(19) United States
(12) Patent Application Publication
(10) Pub. No.: US 2003/0116560 A1
(43) Pub. Date: Jun. 26, 2003

(54) Induction insert for insulated trays

(76) Inventor: Burk Wyatt, Brentwood, TN (US)

Correspondence Address: Jeffrey R. McFaden, Esq., Womble Carlyle Sandridge & Rice, PLLC, Suite 1900, 300 N. Greene Street, Greensboro, NC, 27401, US

(21) Appl. No.: 10/269,100

(22) Filed: Oct. 10, 2002

Related U.S. Application Data
(60) Provisional application No. 60/334,237, filed on Nov. 29, 2001.

(51) Int. Cl. H05B 6/12

(52) U.S. Cl. 219/621

(57) ABSTRACT

A heat retentive food server system is provided, having an insulated tray and cover, the tray containing an induction insert with a heat storage member having a top surface with a coating, wherein the heat storage member is adapted to be heated by electrical induction.

### RELATED APPLICATION

This application is related to and claims priority in, co-pending U.S. Provisional Application Ser. No. 60/334,237, filed Nov. 29, 2001, the disclosure of which is incorporated herein by reference.

### BACKGROUND OF THE INVENTION

1. Field of the Invention

The present invention relates to heat retentive food server systems, and particularly a heat retentive food server system that comprises an induction insert that is to be heated by electrical induction. More particularly, the present invention relates to a heat retentive food server system that comprises an insulated tray with an insulated cover where the tray is adapted to receive an induction insert having a coated heat storage member that is capable of being heated by electrical induction.

2. Description of Related Art

In environments where food is prepared and cooked in a central location and distributed and served to consumers who are remotely located, such as in hotels, in aircraft and in institutional settings such as hospitals and nursing homes, there is often a delay between the time that the food is prepared, cooked and subsequently placed on a plate or other serving dish, and the time that the food is eventually presented to the consumer for consumption at a remote location, such as a hotel room, hospital room, on aircraft, etc. Accordingly, by the time the food is presented to the consumer, the food can become cold unless special measures are taken to keep the food hot. Various approaches to such meal service problems encountered in such service environments, sometimes referred to as “satelliting,” have been employed in the food service and container industries.

One particular embodiment of heat retentive servers can be designed to support dishware, which in turn holds a portion of a meal that is to be kept hot. In such circumstances, such a base is commonly called a “pellet” base, and the entire system, i.e., the tray, base, dome and plate, is referred to as a “pellet system.” When a heat sink is incorporated into a server base and the base supports a food-carrying dish, such as a plate, the base can be referred to as a plate warmer.

In general, heat retentive servers employ convection or conduction heating in order to either heat a food service dish or heat a heat storage battery during food service operations.

U.S. Pat. No. 3,916,872 to KREIS et al., issued Nov. 4, 1975, discloses a heat storage dish comprising a central heat storage disk and an insulating member that surrounds the heat storage dish. The heat storage dish consists of a substantially circular metallic body member that may be equipped with a central opening. The heat storage dish may, for example, be heated by subjecting it to a high frequency field, thus inductively heating the heat storage dish. U.S. Pat. No. 3,557,774, issued Jan. 26, 1971 to KREIS, discloses a heat storage dish having a heat storage metal plate enclosed between an interior wall and an exterior wall, secured at their edges to prevent the entry of any external substance.

U.S. Pat. No. 4,776,386 to MEIER, issued Oct. 11, 1988, discloses an apparatus for cooling, storing and reheating food using induction heating. This system includes a tray distribution system wherein a tray, which may be adapted to support, e.g., a soup tureen, a dish for meat, a hot beverage cup, a salad plate, and/or a similar plate such as a fruit dish, as well as a trough for cutlery, may be provided. A meal, supported on such a tray can be stored in a refrigerated environment. In this system, the refrigerated cabinet in which the trays are stored includes induction coils. In practice, prior to serving, the cooling system of the refrigerator is turned off and the induction coils are activated to supply heat to the appropriate areas in the tray. U.S. Pat. No. 4,881,590 to MEIER, issued Nov. 21, 1989, discloses a similar system.

U.S. Pat. No. 3,734,077 to MURDOUGH et al., issued May 22, 1973, discloses a server that includes a recess in order to receive a plate. The server comprises an upper shell, a lower shell, a heating pellet and a resilient pad. The pad occupies the space between the under surface of the pellet and the lower shell and performs an insulating function.

Each of the forgoing systems suffers from disadvantages. For example, systems which employ convection or conduction heating to preheat a food service container prior to employing the food service container to support, e.g., a dish having a food portion which is to be kept hot, require long “lead times” prior to being capable of being effectively used. Thus, such systems require relatively long periods of time in order to preheat the convection systems or other ovens used with said systems and in order to store enough heat in a heat sink or other heat storage means before the container can be usefully employed to keep foods warm in food service environments. Such lead times are undesirable and are typically on the order of about 60 to about 90 minutes and sometimes even longer, prior to the start of delivery or serving of the food to individual consumers.

Such food service containers suffer from other disadvantages. For example, the entire server can become hot and difficult to handle safely. Additional disadvantages include the fact that heat retentive servers which act as a heat sink, e.g., which employ a heat storage mass, tend to liberate heat in all directions. However, it is preferable to direct the heat which is liberated from the heat storage mass such that the heat is liberated substantially only within the heat retentive server itself, i.e., that portion of the heat retentive server which is enclosed by the bottom portion, side walls and dome or lid of the server. To achieve such an object, it is preferable to direct the heat given up by the heat storage mass such that the heat is directed upwardly.

U.S. Pat. No. 4,982,722 to Wyatt is directed to a transportable heat retentive server base, which includes a disk-shaped central portion having a disk-shaped heat storage member. The '722 Wyatt base design, though an improvement over the above-described inventions, has a base having an upper shell and a lower shell that hermetically seal a cavity formed therebetween. A heat storage member is disposed within the cavity and comprises a casing, which further encapsulates a heat storage core. Thus, the '722 Wyatt design has a heat storage core that is doubly encased in the base.

Similarly, U.S. Pat. No. 5,786,643 to Wyatt et al. is directed to a transportable heat retentive server, which includes a disk-shaped central portion having a disk-shaped heat storage disk. The '643 Wyatt et al. server design, though an improvement over the above-described inventions, has a heat storage disk that is surrounded and housed between an upper member and a lower member. This encapsulation of the heat storage disk in the base is accomplished in a number of ways including welding, adhesive bonding or integrally molding as a single piece to surround the heat storage disk.

The present invention is distinguished from the above-described bases because the heat storage disk of the induction insert is not encapsulated in a heat retentive base. Instead the heat storage disk is exposed and has a top coating, preferably of epoxy, zinc, nickel, chrome or stainless steel, and is fitted in an induction insert. Moreover, the induction insert is then fitted into an insulated tray after activation and adapted such that a plate can securely fit in the induction insert. The primary advantage of the unique configuration of heat retentive server systems according to the present invention, is that it is capable of maintaining the temperature of the food product at 140° F. or above for approximately 2 to 2.5 times longer than an insulated tray system without the induction insert, assuming the food product and the plate start at 165 degrees F.

### SUMMARY OF THE INVENTION

The present invention provides a heat retentive food server system having an induction insert that is adapted to be inductively heated and then inserted into an insulated tray so as to keep hot foods hot. Further, the heat retentive food server system includes an insulated cover, which is thermally disposed over the insulated tray such that it completely covers the induction insert and a plate disposed therein, thereby providing additional heat retention.

The present invention provides an induction insert that can be heated by induction heating to keep selected foods hot. The induction insert includes a heat storage disk or member, or metal portion, which is heated to a predetermined temperature in response to electrical or electromagnetic induction, e.g., by induction heating. The heat storage disk is preferably centrally located and fitted into the induction insert such that its top surface has a coating that is exposed from the induction insert. Preferably, the induction insert and heat storage disk are concentrically located and are circular, but can be positioned in various locations and can comprise other than a circular shape. Additionally, the heat retentive server system of the present invention further comprises an insulated cover, wherein the insulated cover and insulated tray can cooperate to define an insulated volume.

The present invention provides an induction insert for a heat retentive insulated server having a heat storage member that can be heated by induction heating and a housing for the heat storage member. The induction insert can be removably inserted into the heat retentive insulated server. The housing can be adapted to direct heat upward from the heat storage member. The heat storage member can have a top surface and a bottom surface with the bottom surface being disposed in the housing and at least a portion of the top surface being exposed to the atmosphere. The exposed top surface can have a coating that is scratch resistant, heat resistant or chemical resistant, or any combination thereof. The exposed top surface can have a coating of epoxy, zinc, nickel, chrome or stainless steel.

The heat retentive server can have an insulated tray and an insulated cover with the insulated tray being adapted to removably receive the induction insert. The insulated cover can be removably secured to the insulated tray to provide an insulated volume for the induction insert. The heat storage member can be circular. The heat storage member can be centrally positioned in the induction insert. The heat storage member is preferably made of steel. Alternatively, the heat storage member is aluminum having magnetic stainless steel clad on both sides thereof. The induction insert can have a thermal break between the housing and the heat storage member.

The housing can have a bottom shell and a top ring secured to each other with the bottom shell covering the bottom surface of the heat storage member and the top ring covering an outer periphery of the top surface of the heat storage member. The housing can also have a seal between the bottom shell and the top ring. The housing can have an annular cavity between the bottom shell and the top ring and the seal can be an o-ring disposed in the annular cavity. The induction insert can have a pressure relief plug in fluid communication with the heat storage member.

The present invention also provides a heat retentive server system comprising an induction insert having a heat storage member that can be heated by induction heating, an insulated tray adapted to removably receive the induction insert and an insulated cover. The induction insert can have a housing for the heat storage member and the housing can be adapted to direct heat upward from the heat storage member. The induction insert can have a housing for the heat storage member and the heat storage member can comprise a top surface and a bottom surface, wherein the bottom surface is covered by the housing and at least a portion of the top surface is exposed to the atmosphere. The exposed top surface can have a coating that is scratch resistant, heat resistant or chemical resistant, or any combination thereof. The exposed top surface can have a coating of epoxy, zinc, nickel, chrome or stainless steel.

The insulated cover can be removably secured to the insulated tray to provide an insulated volume for the induction insert. The heat storage member can be circular. The heat storage member can be centrally positioned in the induction insert. The heat storage member is preferably made of steel. Alternatively, the heat storage member can be made of aluminum having magnetic stainless steel clad on both sides thereof. The system can have a thermal break between the housing and the heat storage member. The housing can have a bottom shell and a top ring secured to each other with the bottom shell covering the bottom surface of the heat storage member and the top ring covering an outer periphery of the top surface of the heat storage member.

The housing can have a seal between the bottom shell and the top ring. The housing can have an annular cavity between the bottom shell and the top ring and the seal can be an o-ring disposed in the annular cavity. The insulated tray can have a cavity for receiving the induction insert and the cavity can be formed by an annular wall. The annular wall can have a height that is higher than the heat storage member. The induction insert can have a pressure relief plug in fluid communication with the heat storage member.

The present invention is also directed to a method of serving food product to a plurality of consumers. The method has the steps of:

A. subjecting an induction insert having a heat storage member which is susceptible to electrical induction heating, to an electromagnetic field sufficient to inductively heat the heat storage member, with the heat storage member having a top surface with a coating on at least a portion thereof;

B. inserting the heated induction insert into an insulated tray such that the coated top surface of the heat storage member, is exposed to the atmosphere;

C. placing a quantity of food product which is disposed on a heated plate, on the induction insert and insulated tray;

D. covering the tray, induction insert, heated plate and food product with an insulated cover that defines an insulated volume between the insulated cover and the insulated tray so that ambient atmosphere does not come into contact with the induction insert, plate and food product, thereby maintaining the food product at or above 140° F. for approximately 2 to 2.5 times longer than the insulated server system without the induction insert; and

E. serving the food product to at least one of a plurality of consumers.

### BRIEF DESCRIPTION OF THE DRAWINGS

FIG. 1 is a top view of the induction insert of the present invention;

FIG. 2 is a bottom view of the induction insert of FIG. 1;

FIG. 3 is a front cross-sectional view of the induction insert of FIG. 1, taken along line A-A of FIG. 1;

FIG. 4 is a side cross-sectional view of the induction insert of FIG. 1, taken along line B-B of FIG. 1;

FIG. 5 is a schematic cross-sectional representation of an alternative embodiment of the induction insert of the present invention;

FIG. 6 is a schematic cross-sectional representation of the induction insert of FIG. 5 contained within one embodiment of the heat retentive food server system of the present invention;

FIG. 7 is top perspective view of an activator of the present invention;

FIG. 8 is a cross-sectional view of the activator of FIG. 7 taken along line 4-4 of FIG. 7; and

FIG. 9 is a graph plotting the temperature of food with respect to time for the heat retentive food server system with induction insert of the present invention versus server system without the induction insert.

### DETAILED DESCRIPTION OF THE PREFERRED EMBODIMENT

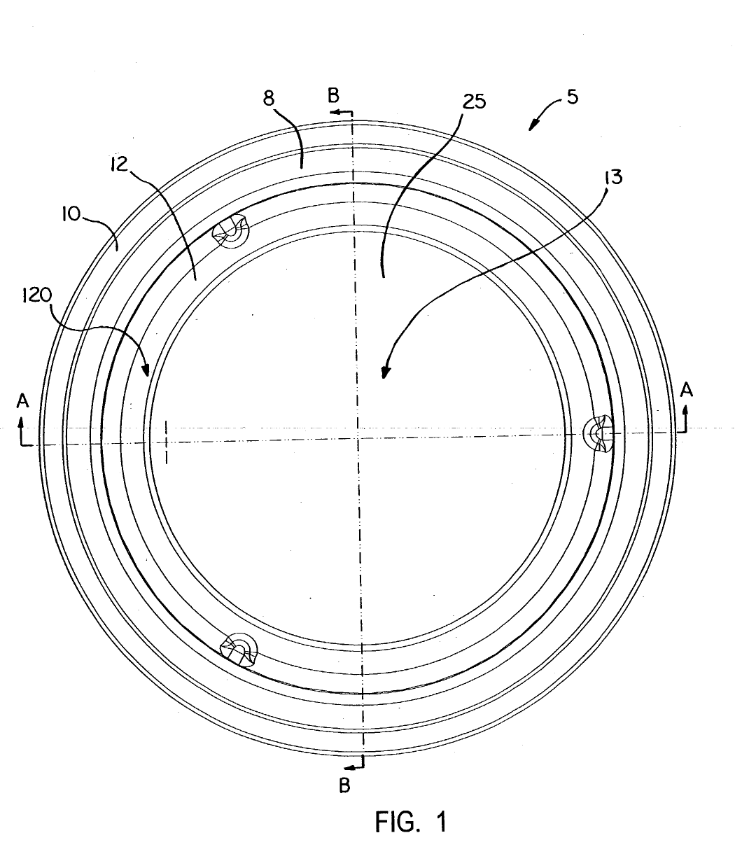

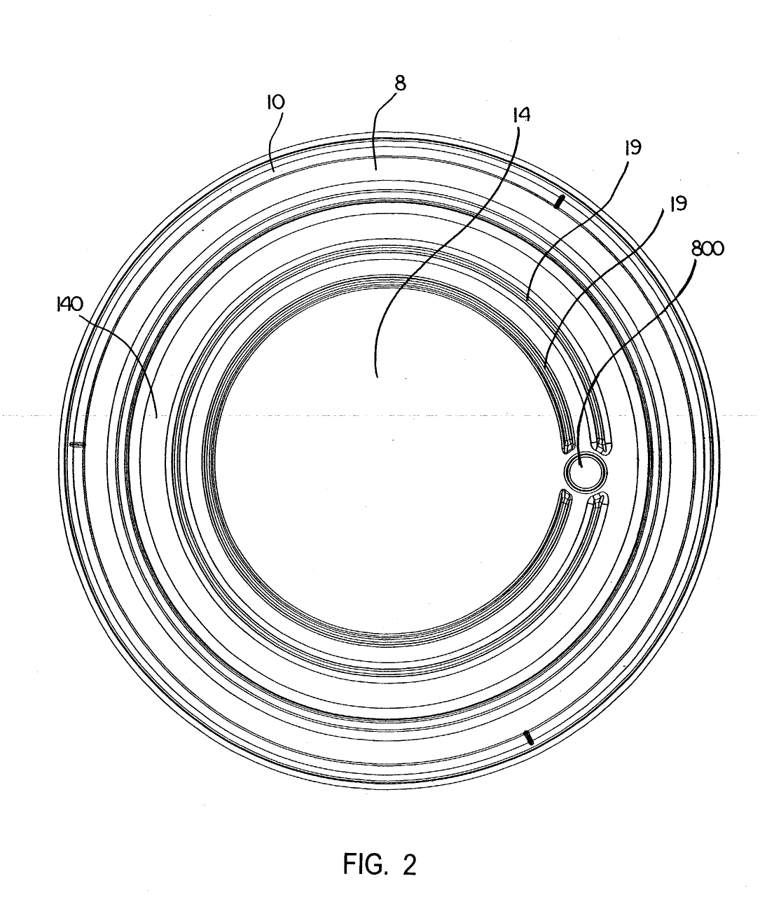

Referring to FIGS. 1 through 4, there is shown a preferred embodiment of an induction insert for the heat retentive insulated food server system of the present invention generally represented by reference numeral 5.

Induction insert 5 has a cup-like shape and comprises a top ring 8, a bottom shell 14 and a heat storage member or disk 20. Top ring 8 is substantially vertical with an upper flange 10 extending outwardly from the top of top ring 8, and a lower flange 12 extending inwardly from the bottom of top ring 8. Lower flange 12 extends inwardly defining a ring opening 13. Top ring 8 is secured to an outer periphery 140 of bottom shell 14 along lower flange 12 to form a housing 100 for heat storage disk 20. The securing of the top ring 8 to bottom shell 14 is preferably accomplished by solvent bonding at joint 16. Alternative securing means can be used including, but not limited to, sonic welding, ultrasonic welding, spin welding, or adhesive bonding.

Bottom shell 14 further comprises two bottom annular rings 19 that are used for removably inserting or positioning induction insert 5 on or into an insulated tray 30, which will be discussed in further detail later.

Bottom shell 14 is compatible with existing activators or induction heating units. Bottom shell 14 can also be formed of suitable plastic materials. Preferably, bottom shell 14 is formed of heat resistant material, such as glass filled plastic resin materials. For embodiments wherein bottom shell 14 and top ring 8 are ultrasonically welded, preferred materials are those which can be ultrasonically welded, but which are also heat resistant. Suitable resins can be selected by those of ordinary skill in the art. Preferably, the resin is RADEL® glass filled resin available from Solvay of Atlanta, Ga. Alternative resins include VALOX® glass filled resin, ULTEM® resin and NORYL® resin, available from General Electric, of Pittsfield, Mass. Preferably, the resins are glass filled.

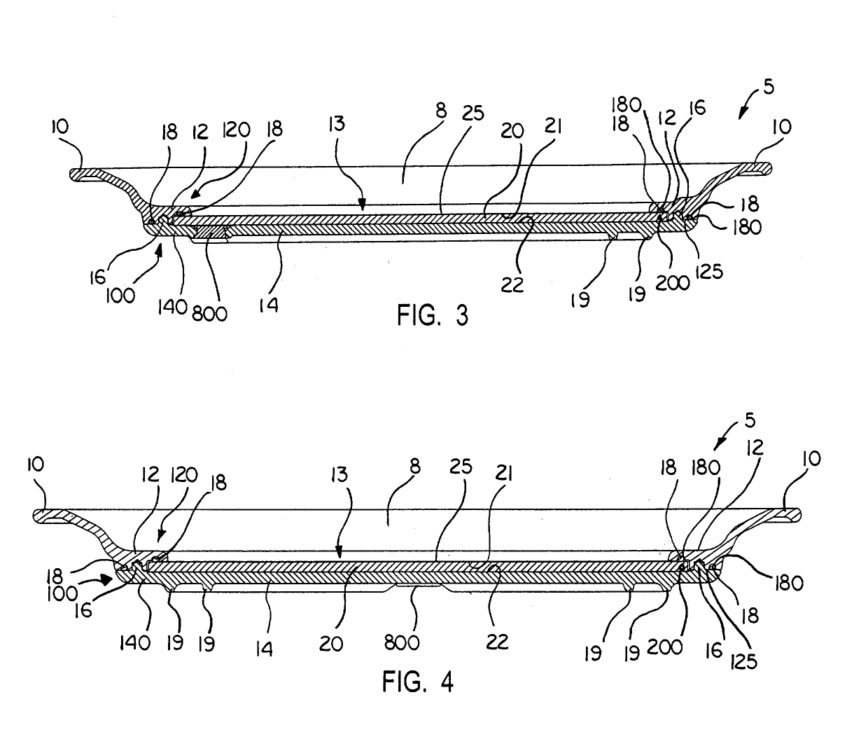

Heat storage disk 20 has a top surface 21 and a bottom surface 22. Heat storage disk 20 is secured between an inner periphery 120 of lower flange 12 and an outer periphery 140 of bottom shell 14 such that heat storage disk 20 and ring opening 13 are substantially concentrically aligned. In the embodiment of FIG. 3, bottom shell 14 cooperates with top ring 8 to surround bottom surface 22 of heat storage disk 20. Heat storage disk 20 is made of a material to optimize induction heating. Preferably, heat storage disk 20 is made from steel. More preferably, heat storage disk 20 is made from steel produced by a cold rolling process. Alternatively, heat storage disk 20 can be made from aluminum with magnetic stainless steel clad on both sides.

It has been found that when a metal disk is employed for heat storage disk 20, preferred results are obtained by optimizing a combination of mass of metal disk 20, diameter of metal disk 20, and thickness of metal disk 20. In preferred embodiments, a mass of from about 450 grams to about 475 grams is preferred, an outer diameter of about 6.3 inches to about 6.5 inches is preferred, and a thickness of about 0.117 inch to about 0.125 inch is preferred.

Top surface 21 of heat storage disk 20 comprises a coating 25. Preferably, coating 25 is scratch resistant, heat resistant and/or chemical resistant. These properties are preferred because heat storage disk 20 is subjected to temperatures up to about 420° F. and subjected to commercial dishwashers where the heat storage disk is exposed to washing chemicals and rinse additives. Preferably, coating 25 is an epoxy, zinc, nickel, chrome or stainless steel.

Induction insert 5 further comprises O-ring seals 18. O-ring seals 18 are positioned along an outer periphery 200 of heat storage disk 20 and outer periphery 140 of bottom shell 14. O-ring seals 18 are housed in annular grooves 180 that are formed along a bottom surface 125 of lower flange 12. O-ring seals 18 serve two purposes: (1) to prevent water infiltration; and (2) to provide a thermal expansion joint. This joint comprises a thermal break. As used herein, the term “thermal break” refers to the inability of two or more parts to transmit heat one to the other by conduction due to a lack of direct contact between the parts which are subject to the thermal break, whereby the parts are “substantially thermally insulated from each other.”

Top ring 8 is preferably of a depth, diameter and shape such that a plate fits securely in induction insert 5 with the sides of the plate resting firmly against top ring 8. Preferably, induction insert 5 accommodates standard 9″ dishware. However, it can be adapted to accommodate other sizes and shapes of dishware.

Induction insert 5 of the present invention is constructed so as to retain the heat that is liberated from heat storage member 20 in the area of the food product. This is preferably accomplished by directing the liberated heat upwardly from heat storage disk 20 through ring opening 13 of top ring 8.

Heat storage disk 20 has only a coating 25 between disk 20 and the plate, which further facilitates the upward heat transfer from disk 20 to the plate, as opposed to previous designs in which the heat storage disk was encased in a housing within the base. Induction insert 5 also has a pressure relief valve or blow-out plug 800. However, alternative embodiments of the present invention may not require a pressure relief valve or plug because heat storage disk 20 is not fully encapsulated or enclosed.

It has also been found that there are important considerations relating to the distance of heat storage disk 20 from an electromagnetic or induction coil, in the practice of the invention. It has been found that it is critical that heat storage disk 20 not be located too far away from the induction coil. For example, if disk 20 is too far away from the induction coil, heating will not be induced. Generally, a distance of from about 0.350 inch to about 0.650 inch from the top of the induction coil to bottom surface 22 of heat storage disk 20 should be employed. This is accomplished by optimizing the thickness of an induction heating top or operating surface and/or the thickness of the material under heat storage disk 20. In general, the top of the induction heating unit should have a thickness which cooperates with the dimensions of induction insert 5 such that bottom surface 22 of heat storage disk 20 is located from about 0.350 inch to about 0.650 inch from the top surface of the induction coil, and preferably from about 0.375 inch to about 0.625 inch.

The minimum hold time for the system is about one hour when the dish temperature is 165° F. (food temp is 165° F.) assuming that an insulated cover is placed over induction insert 5 on the tray at a speed of 3.5 trays per minute. The present system extends the “hold time” of the food above 140° F. for a time period from 22 minutes for conventional heat retentive insulated servers to about 65 to 75 minutes with the novel induction insert system. Induction insert 5 of the present invention is activated by an induction heater within a period of, for example, from about 5 to about 15 seconds, and preferably from about 8 to about 12 seconds.

Preferably, induction insert 5 is subjected to induction heating conditions of an intensity and for a time sufficient to heat heat storage disk 20 to a temperature of from at least about 350° F. to about 420° F., preferably from about 360° F. to about 385° F. A further advantage of the present invention is that induction insert 5 can be heated without subjecting the remaining components of the heat retentive server system to undue thermal stress.

When a metal heat storage disk 20 is employed, it is preferably heated to such a temperature range as measured by physically contacting a probe (e.g., a thermocouple) to metal disk 20 and conducting measurements of the temperature of disk 20 at various locations throughout the surface of disk 20. A brief period of time is permitted in order to allow the temperature of disk 20 to equilibrate (i.e., to allow the heat to spread evenly throughout the volume of the disk). Equilibration is necessary before measurement because the induction heating coil can generate hot spots.

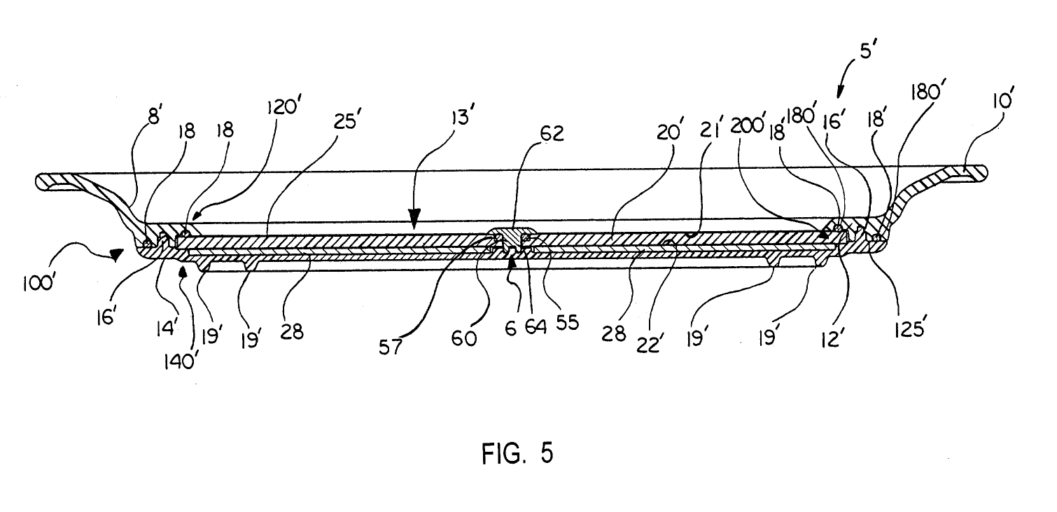

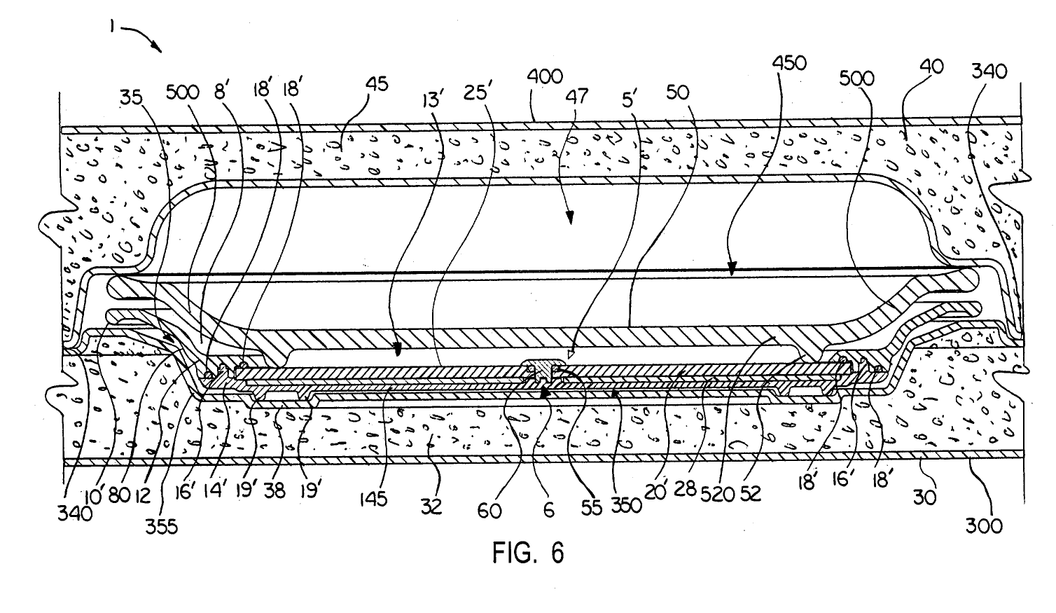

Referring to FIGS. 5 and 6, there is shown an alternative embodiment of the heat retentive insulated food server system of the present invention generally represented by reference numeral 1. The heat retentive food server system 1 comprises an induction insert 5′, an insulated tray 30, an insulated cover 40 and a plate 50. While FIG. 6 shows tray 30, cover 40 and plate 50 being used with induction insert 5′, it should be understood that the preferred embodiment of induction insert 5 is also used in heat retentive food server system 1 with tray 30, cover 40 and plate 50.

Referring to FIG. 5, a cross section of induction insert 5′ is shown. Induction insert 5′ has a cup-like shape with a top ring 8′, a bottom shell 14′ and a heat storage member or disk 20′. Top ring 8′ has an upper flange 10′ and a lower flange 12′. Lower flange 12′ extends inwardly defining a ring opening 13′. Top ring 8′ is secured to an outer periphery 140′ of lower flange 12′ to form a housing 100′ for heat storage disk 20′. The securing of the top ring 8′ to bottom shell 14′ can be accomplished through suitable securing means including, but not limited to, solvent bonding, sonic welding, ultrasonic welding, spin welding, and adhesive bonding.

In this embodiment, an annular ultrasonic weld joint 16′ is provided that has a lead, which spreads or flashes up each side of weld joint 16′ during welding. Bottom shell 14′ has two bottom annular feet or rings 19′.

Bottom shell 14′ is compatible with existing activators or induction heating units. Bottom shell 14′ can also be formed of suitable plastic materials. Preferably, bottom shell 14′ is formed of heat resistant material, such as glass filled plastic resin materials. For embodiments wherein bottom shell 14′ and top ring 8′ are ultrasonically welded, preferred materials are those which can be ultrasonically welded, but which are also heat resistant. Suitable resins can be selected by those of ordinary skill in the art.

Heat storage disk 20′ has a top surface 21′ and a bottom surface 22′. Heat storage disk 20′ is secured between an inner periphery 120′ of lower flange 12′ and outer periphery 140′. Preferably, heat storage disk 20′ and ring opening 13′ are substantially concentrically aligned. Bottom shell 14′ cooperates with top ring 8′ to surround bottom surface 22′ of heat storage disk 20′. Heat storage disk 20′ is made of a material to optimize induction heating such as steel and steel produced by a cold rolling process. Heat storage disk 20′ can also be made from aluminum clad on both sides with magnetic stainless steel.

Preferably, heat storage disk 20′ has a mass of from about 450 grams to about 475 grams, an outer diameter of about 6.3 inches to about 6.5 inches and a thickness of about 0.117 inch to about 0.125 inch.

Top surface 21′ of heat storage disk 20′ comprises a coating 25′ that is scratch resistant, heat resistant and/or chemical resistant. These properties are preferred because heat storage disk 20′ is subjected to temperatures up to about 420° F. and subjected to commercial dishwashers where the heat storage disk is exposed to washing chemicals and rinse additives. Preferably, coating 25′ is an epoxy, zinc, nickel, chrome or stainless steel.

Heat storage disk 20′ has a hole 6 formed therein. Preferably, hole 6 is a center hole 6. Hole 6 allows disk 20′ to be secured to bottom shell 14′. A securing pin 60 having a top portion 62 wider than hole 6 and a bottom portion 64 narrower than hole 6, passes through center hole 6 until the underside of top portion 62 engages storage disk 20′. Pin 60 is then secured to bottom shell 14′. Preferably, pin 60 is secured to bottom shell 14′ by ultrasonic welding. A center O-ring 55 is positioned between top portion 62 of securing pin 60 and storage disk 20′. Preferably, center hole 60 has an annular ledge 57 upon which O-ring 55 sits.

Induction insert 5′ further comprises fiberglass insulation 28 and O-ring seals 18′. Fiberglass insulation 28 is positioned along bottom surface 22′ of heat storage disk 20′ and is housed by bottom shell 14′. A further advantage of the present invention is that the amount of fiberglass insulation 28 is reduced because the induction insert is fittedly engaged onto insulated tray 30, which will be discussed in further detail later. O-ring seals 18′ are positioned along an outer periphery 200′ of heat storage disk 20′ and outer periphery 140′ of bottom shell 14′. O-ring seals 18′ are housed in annular grooves 180′ that are formed along a bottom surface 125′ of lower flange 12′. O-ring seals 18′ prevent water infiltration and provide a thermal expansion joint or thermal break.

Referring to FIG. 6, insulated tray 30, insulated cover 40 and plate 50, are also shown. Insulated tray 30 comprises a foam insulation 32. Due to the volume of insulated tray 30, a substantial amount of insulation 32 may be utilized which significantly reduces the amount of fiberglass insulation 28 that is needed in induction insert 5′. Insulated tray 30 further comprises an insert cavity 35. Preferably, insert cavity 35 is formed by a substantially annular wall 355. Insert cavity 35 is preferably centrally located on insulated tray 30. However, insert cavity 35 can be other than centrally located and also can be a plurality of insert cavities to accommodate a plurality of induction inserts 5′. Insert cavity 35 is of a depth, diameter and shape so as to allow induction insert 5′ to fittingly engage therein. Insert cavity 35 comprises an annular insert channel 38 located in its base and aligned under bottom annular rings 19′. This provides further engagement means between induction insert 5′ and insulated tray 30, and allows a center portion 145 of bottom shell 14′ to lie flush against a center portion 350 of insert cavity 35 providing further stability.

An outer surface 300 of insulated tray 30 can be composed of any suitable weldable or bonded material such as a plastic material, preferably an injection-moldable plastic material such as a polyolefin-based plastic materials, e.g., polypropylene. Other suitable materials can be readily selected by those of ordinary skill in the art. Alternatively, insulated tray 30 and insulated cover 40 may use a friction fit or snap fit, as described in U.S. Pat. No. 5,145,090 to WYATT, the disclosure of which is incorporated in its entirety herein by reference.

Plate 50 has sides 500 that rest against top ring 8′. Preferably, induction insert 5′ accommodates standard 9″ dishware. However, it can be adapted to accommodate other sizes and shapes of dishware. In this embodiment, plate 50 comprises an annular rim 52 protruding downwardly from a base 520. Annular rim 52 rests upon coating 25′ of heat storage disk 20′.

Insulated cover 40 has a foam insulation 45 and an upper cavity 47. Insulated cover 40 is adapted to engage with insulated tray 30 such that upper cavity 47 and insert cavity 35 are substantially concentrically aligned and create an insulated volume 450 in which induction insert 5′ and plate 50 are contained. Foam insulation 45 provides additional heat retentive properties for the heat retentive server system 1.

Induction insert 5′ of the present invention is constructed and arranged in insulated tray 30 so as to retain the heat that is liberated from heat storage member 20, within insulated volume 450 defined by upper cavity 47 and insert cavity 35. This is preferably accomplished by directing the liberated heat upwardly from heat storage disk 20′ through ring opening 13′ of top ring 8′. Fiberglass insulation 28′ serves to reduce or prevent heat loss from bottom surface 22′ of heat storage disk 20′ and directs the heat upwardly and inwardly to direct the heat to plate 50 containing food. Foam insulation 32 serves to reduce or prevent heat loss from the bottom and sides of induction insert 5′ and directs the heat upwardly and inwardly to direct the heat to plate 50 containing food.

Heat storage disk 20′ has only a coating 25′ between disk 20′ and plate 50 that further facilitates the upward heat transfer from disk 20′ to plate 50, as opposed to previous designs in which the heat storage disk was encased within a housing inside the base. Moreover, the design of the present invention may not require a pressure relief plug because heat storage disk 20′ is not encapsulated or enclosed. Alternative embodiments may use a safety blow-out plug or pressure relief valve.

Additionally, one influence that contributes to the retention of heat in foods placed in the present device, is the rising of heat away from the annular contact area or point 340 between insulated cover 40 and insulated tray 30. The heat moves upwardly into the food and continues to rise up to a top 400 of insulated cover 40, thereby moving away from contact point 340 at which cover 40 and tray 30 meet. Annular wall 355 of insulated tray 30 has a height that is higher than heat storage disk 20′ when induction insert 5′ is disposed in insert cavity 35. This upward movement of heat is further facilitated by foam insulation 32 in insulated tray 30 that is adjacent to an undersurface 80 of top ring 8′. Thus, less leakage of heat occurs by virtue of the present device design.

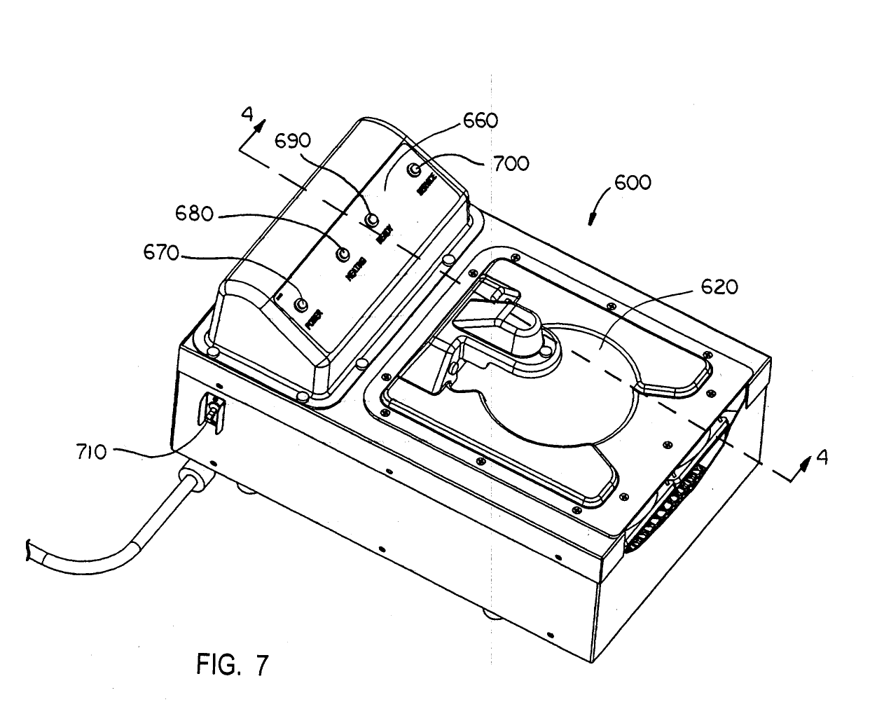

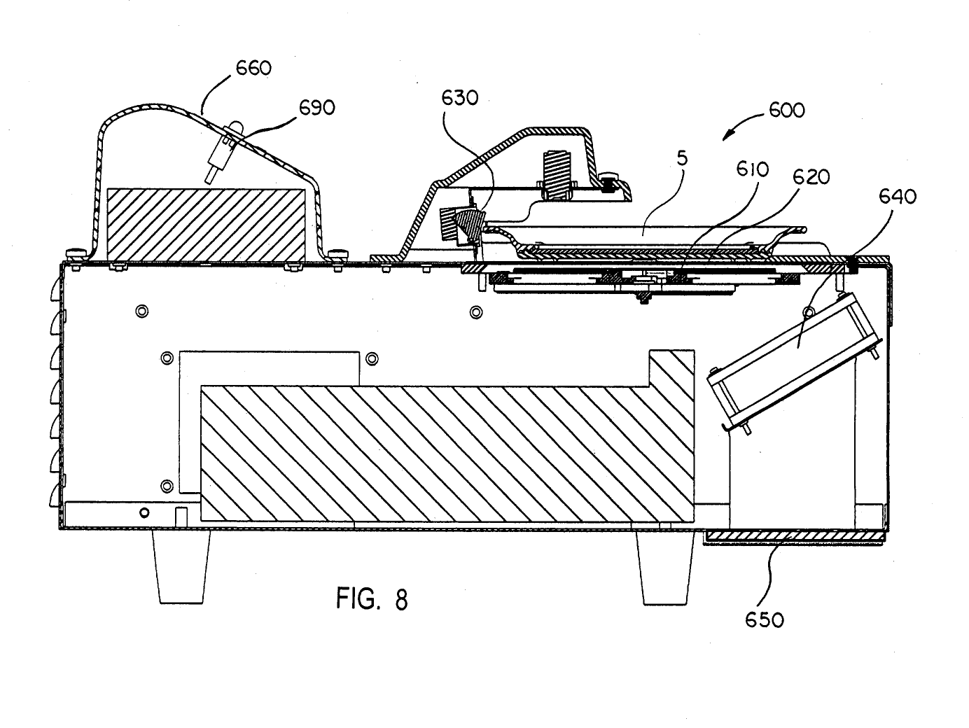

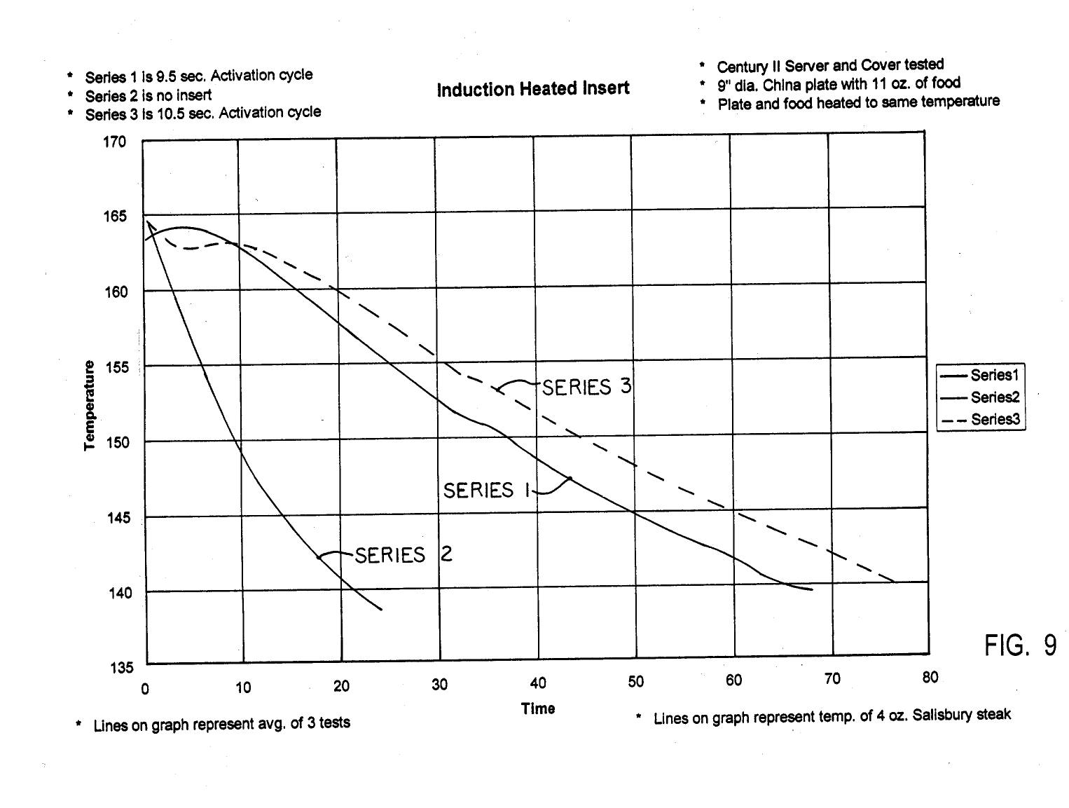

Referring to FIGS. 7 and 8, the induction heating of the invention is preferably conducted by placing induction insert 5 (or 5′) on an activator or induction heating unit 600 that is capable of producing heat-generating electric currents, e.g., a magnetic field generated by an electric current. Induction insert 5 can then be fitted into insulated tray 30 after activation. The basic principles of induction heating are well-known to those of ordinary skill in the art, and are disclosed for example, in U.S. Pat. No. 4,453,068 to TUCKER et al. The entirety of this patent, and all patents and publications cited therein, are hereby incorporated by reference as though set forth in full herein, for their disclosures of the basic principles and circuitry employed in induction heating. Preferred induction heating systems are described in more detail below.

It has also been found that there are important considerations relating to the distance of heat storage disk 20 from an electromagnetic or induction coil 610, in the practice of the invention. It has been found that it is critical that heat storage disk 20 not be located too far away from induction coil 610. For example, if disk 20 is too far away from induction coil 610, heating will not be induced. This is accomplished by optimizing the thickness of an induction heating top or operating surface 620 and/or the thickness of the material under heat storage disk 20, i.e., fiberglass insulation 28 and bottom shell 14.

The minimum hold time for the system is about one hour when the dish temperature is 165° F. (food temp is 165° F.) assuming that insulated cover 40 is placed over induction insert 5 (or 5′) on tray 30 at a speed of 3.5 trays per minute. The present system extends the “hold time” of the food above 140° F. for a time period from 22 minutes for conventional heat retentive insulated servers to about 65 to 75 minutes with the novel induction insert system 1.

Induction insert 5 of the present invention is activated within a period of, for example, from about 5 to about 15 seconds, and preferably from about 8 to about 12 seconds. Heating is preferably accomplished by placing induction insert 5 on operating surface 620 of induction heating unit 600. Preferably, the system is activated, or energized in response to a mechanical switch 630 that is activated by the presence of induction insert 5. Induction heating unit 600 is preferably provided with a safety interlock system, whereby mechanical switch 630 cannot be activated unless a guard is first displaced in response to the presence of induction insert 5.

Induction heating unit 600 also preferably includes a coil cooling fan 640 and air filter 650, each of which are fully conventional and readily available. Also included is an inverter. Exemplary of suitable inverters is that available from Fuji Electric, of Japan. Those of ordinary skill in the art can readily design and/or fabricate a suitable inverter. An EMI filter is also preferably included. Those of ordinary skill in the art can readily design and/or fabricate a suitable filter. Advantageously, induction heating unit 600 is also provided with a control panel 660.

Control panel 660 includes a “power on” indicator 670, a “heating” indicator 680, a “ready” indicator 690 and a “service” indicator 700. Suitable additional indicators and/or controls will be readily apparent to those of ordinary skill in the art.

In use, power to the unit is turned on at power switch 710 and induction insert 5 is placed on top or operating surface 620 of unit 600. Mechanical switch 630 allows coil 610 to be energized, and heating indicator 680 is activated. Heat storage disk 20 is heated during this interval, which has the values in the ranges defined above. When a suitable time interval has passed to bring heat storage disk 20 to the desired temperature range as discussed above, induction coil 610 is de-energized and ready indicator 690 is activated. Induction insert 5 may then be removed from induction heating unit 600, and positioned in insert cavity 35 of insulated tray 30. Plate 50 containing food therein may then be placed in induction insert 5. This process can be repeated sequentially many times, the number of repetitions being chiefly dependent upon the number of meals to be served. The plated food, so placed on the server systems 1, is then served to remotely-located consumers. A holding period of finite duration will occur from the time that plate 50 having hot food thereon is placed on system 1 and the time that the plate having such food in the plate is presented to the consumer. This duration will vary, depending on whether, for example, a particular tray 30 is the first or last in a series to be provided with plate 50 having food thereon. The duration will also be dependent upon practices that normally occur at institutions such as those described, which practices are normally variable.

FIG. 9 illustrates the significant difference between the performance of the present heat retentive server system 1 with induction insert 5 (or 5′) over an insulated server system without induction insert 5. The graph monitors three series. Series 1 and Series 3 have insulated trays 30 and covers 40 with induction insert 5 activated for 9.5 second and 10.5 second cycles, respectively. Series 2 is a conventional heat retentive insulated server system without induction insert 5. Results shown on the graph were an average of three tests for each Series. The food temperature shown is that of a 4 oz. Salisbury steak on a 9-inch china plate with a total mass of 11 ounces of food.

The results from the graph show a surprisingly significant improvement for the present induction insert system 1 including insulated tray 30 and insulated cover 40. A temperature of 140° F. was maintained for about 65 minutes to 75 minutes with server system 1 and induction insert 5, which is significantly higher than conventional servers, which have been shown to only maintain a temperature of 140° F. for 22 minutes.

The design of induction insert 5 (or 5′) is a significant improvement upon conventional induction bases because heat storage disk 20 is positioned within induction insert 5 with only a coating 25 on top surface 21 to facilitate upward heat movement through this exposed top surface 21, i.e., there is no plastic skin covering top surface 21 of heat storage disk 20. Also, tray 30 and cover 40 provide insulated volume 450 for induction insert 5. This unique combination of improvements provides the unexpected and significant heat retention shown in FIG. 9.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. An induction insert for a heat retentive insulated server, the induction insert comprising:
a heat storage member that can be heated by induction heating and a housing for said heat storage member, wherein the induction insert can be removably inserted into the heat retentive insulated server.

2. The induction insert of claim 1, wherein said housing is adapted to direct heat upward from said heat storage member.

3. The induction insert of claim 1, wherein said heat storage member comprises a top surface and a bottom surface, said bottom surface being disposed in said housing and wherein at least a portion of said top surface is exposed to the atmosphere.

4. The induction insert of claim 3, wherein said exposed top surface has a coating that exhibits at least one of the properties selected from the group consisting of: scratch resistance, heat resistance and chemical resistance.

5. The induction insert of claim 3, wherein said exposed top surface has a coating selected from the group consisting of: epoxy, zinc, nickel, chrome and stainless steel.

6. The induction insert of claim 4, wherein said heat retentive server comprises an insulated tray and an insulated cover, said insulated tray being adapted to removably receive said induction insert.

7. The induction insert of claim 6, wherein said insulated cover is removably secured to said insulated tray to provide an insulated volume for said induction insert.

8. The induction insert of claim 4, wherein said heat storage member is circular.

9. The induction insert of claim 4, wherein said heat storage member is centrally positioned in said induction insert.

10. The induction insert of claim 4, wherein said heat storage member is steel.

11. The induction insert of claim 4, wherein said heat storage member is aluminum having magnetic stainless steel clad on both sides thereof.

12. The induction insert of claim 4 further comprising a thermal break between said housing and said heat storage member.

13. The induction insert of claim 4, wherein said housing comprises a bottom shell and a top ring secured to each other, said bottom shell covering said bottom surface of said heat storage member and said top ring covering an outer periphery of said top surface of said heat storage member.

14. The induction insert of claim 13, wherein said housing further comprises a seal between said bottom shell and said top ring.

15. The induction insert of claim 14, wherein said housing further comprises an annular cavity between said bottom shell and said top ring, and wherein said seal is an o-ring disposed in said annular cavity.

16. The induction insert of claim 4, further comprising a pressure relief plug in fluid communication with said heat storage member.

17. A heat retentive server system comprising:
an induction insert having a heat storage member that can be heated by induction heating;
an insulated tray adapted to removably receive said induction insert; and
an insulated cover.

18. The heat retentive server system of claim 17, wherein said induction insert further comprises a housing for said heat storage member, and wherein said housing is adapted to direct heat upward from said heat storage member.

19. The heat retentive server system of claim 17, wherein said induction insert further comprises a housing for said heat storage member and wherein said heat storage member comprises a top surface and a bottom surface, said bottom surface being covered by said housing and at least a portion of said top surface being exposed to the atmosphere.

20. The heat retentive server system of claim 19, wherein said exposed top surface has a coating that exhibits at least one of the properties selected from the group consisting of: scratch resistance, heat resistance and chemical resistance.

21. The heat retentive server system of claim 19, wherein said exposed top surface has a coating selected from the group consisting of: epoxy, zinc, nickel, chrome and stainless steel.

22. The heat retentive server system of claim 20, wherein said insulated cover is removably secured to said insulated tray to provide an insulated volume for said induction insert.

23. The heat retentive server system of claim 20, wherein said heat storage member is circular.

24. The heat retentive server system of claim 20, wherein said heat storage member is centrally positioned in said induction insert.

25. The heat retentive server system of claim 20, wherein said heat storage member is steel.

26. The heat retentive server system of claim 20, wherein said heat storage member is aluminum having magnetic stainless steel clad on both sides thereof.

27. The heat retentive server system of claim 20 further comprising a thermal break between said housing and said heat storage member.

28. The heat retentive server system of claim 20, wherein said housing comprises a bottom shell and a top ring secured to each other, said bottom shell covering said bottom surface of said heat storage member and said top ring covering an outer periphery of said top surface of said heat storage member.

29. The heat retentive server system of claim 28, wherein said housing further comprises a seal between said bottom shell and said top ring.

30. The heat retentive server system of claim 29, wherein said housing further comprises an annular cavity between said bottom shell and said top ring, and wherein said seal is an o-ring disposed in said annular cavity.

31. The heat retentive server system of claim 17, wherein said insulated tray has a cavity for receiving said induction insert, and wherein said cavity is formed by an annular wall.

32. The heat retentive server system of claim 31, wherein said annular wall has a height that is higher than said heat storage member.

33. The heat retentive server system of claim 20, wherein said induction insert further comprises a pressure relief plug in fluid communication with said heat storage member.

34. A method of serving food product to a plurality of consumers, the method comprising:
subjecting an induction insert having a heat storage member which is susceptible to electrical induction heating, to an electromagnetic field sufficient to inductively heat said heat storage member, said heat storage member having a top surface with a coating on at least a portion thereof;
inserting said heated induction insert into an insulated tray such that said coated top surface of said heat storage member is exposed to the atmosphere;
placing a quantity of food product which is disposed on a plate, on said induction insert and said insulated tray;
covering said tray, said induction insert, said heated plate and said food product with an insulated cover which defines an insulated volume between said insulated cover and said insulated tray so that atmosphere does not come into contact with said induction insert, said plate and said food product; and
serving said food product to at least one of a plurality of consumers.
